(19) United States
(12) Patent Application Publication
(10) Pub. No.: US 2026/0319657 A1
(43) Pub. Date: Oct. 15, 2026

(54) ELECTRONIC DEVICE

(71) Applicant: ASUSTEK COMPUTER INC, TAIPEI (TW)

(72) Inventors: Yu-Sheng LIN, TAIPEI (TW); Shih-Chan CHIU, TAIPEI (TW)

(21) Appl. No.: 19/306,728

(22) Filed: Aug. 21, 2025

(30) Foreign Application Priority Data
Apr. 10, 2025 (TW) 114113576

(51) Int. Cl. G06F 3/04886; G06F 3/041

(52) U.S. Cl. CPC G06F 3/04886; G06F 3/0412

(57) ABSTRACT

The disclosure provides an electronic device. The electronic device includes a housing, a touch display module, and a touch pad. The housing has an opening. The touch display module is arranged in the housing, and has a touch display surface. The touch pad is arranged in the housing, and has a touch surface. The touch display surface is next to the touch surface, and the touch display surface and the touch surface are exposed through the opening.

### CROSS-REFERENCE TO RELATED APPLICATION

This application claims the priority benefit of Taiwan Application Serial No. 114113576, filed on Apr. 10, 2025. The entirety of the above-mentioned patent application is hereby incorporated by reference herein and made a part of specification.

### BACKGROUND OF THE INVENTION

### Field of the Invention

The disclosure relates to an electronic device, and in particular, to an electronic device provided with both a touch pad and a touch display module.

### Description of the Related Art

When a specific function (such as volume adjustment or screen brightness adjustment) needs to be operated on a conventional notebook computer, the operation often needs to be performed through the “Fn” key on a keyboard and a corresponding function key.

In this way, during operation through a touch pad, a user needs to switch to the keyboard to operate the specific function, which causes inconvenient operation and a waste of time for the user.

### BRIEF SUMMARY OF THE INVENTION

The disclosure provides an electronic device. The electronic device includes a housing, a touch display module, and a touch pad. The housing has an opening. The touch display module is arranged in the housing, and has a touch display surface. The touch pad is arranged in the housing, and has a touch surface. The touch display surface is next to the touch surface, and the touch display surface and the touch surface are exposed through the opening.

When a specific function needs to be operated on a conventional notebook computer, an operation often needs to be performed through the “Fn” key on a keyboard and a corresponding function key, which causes inconvenient operation and a waste of time for a user. In the disclosure, a touch display module and a touch pad are arranged at the opening of the housing of the electronic device, and the touch display surface of the touch display module is next to the touch surface of the touch pad, so that the user directly uses the touch display module to operate (enable) the specific function. In this way, the user directly uses the touch display module next to the touch pad to operate (enable) the specific function without needing to switch to the keyboard, which helps improve the operation process of the user and reduces the time wasted by switching to the keyboard.

### BRIEF DESCRIPTION OF THE DRAWINGS

FIG. 1 is a three-dimensional schematic diagram of an electronic device according to an embodiment of the disclosure;

FIG. 2 is a schematic top view of a host part of the electronic device in FIG. 1;

FIG. 3 is a schematic cross-sectional view corresponding to a section line A-A in FIG. 2;

FIG. 4 is a schematic block diagram of the electronic device in FIG. 1;

FIG. 5 is a schematic diagram of a first user operation interface according to an embodiment of the disclosure;

FIG. 6A to FIG. 6C are schematic diagrams of different display modes of the first user operation interface in FIG. 5;

FIG. 7A to FIG. 7C are schematic diagrams of a second user operation interface according to an embodiment of the disclosure; and

FIG. 8 is a schematic diagram of a second user operation interface according to another embodiment of the disclosure.

### DETAILED DESCRIPTION OF THE EMBODIMENTS

Specific embodiments of the disclosure are described in more details below with reference to the schematic diagrams. Advantages and features of the disclosure are to be clearer according to the following descriptions and claims. It is to be noted that all the figures are in a very simple form and in an inaccurate proportion, and are merely intended to assist description of the purpose of the embodiments of the disclosure conveniently and clearly.

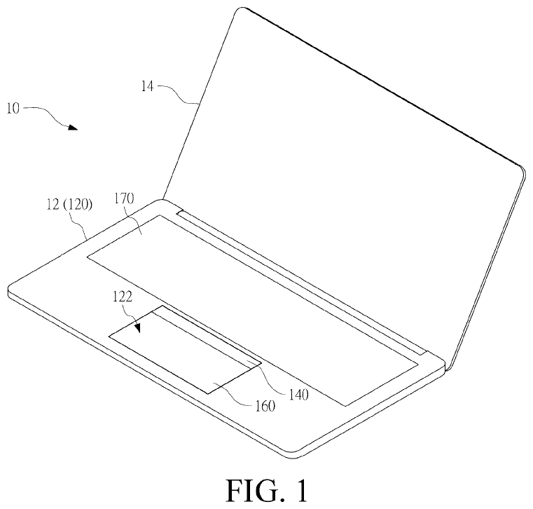

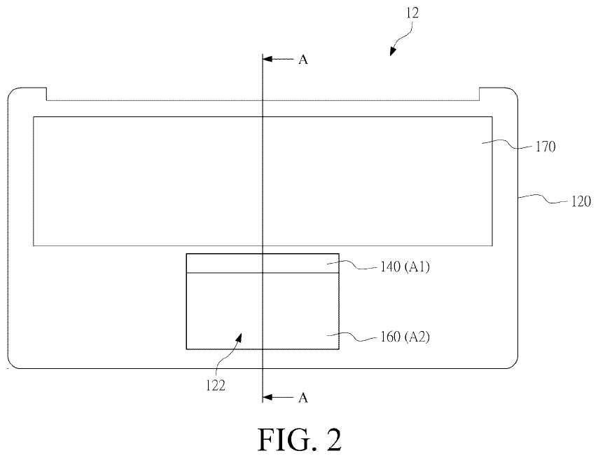

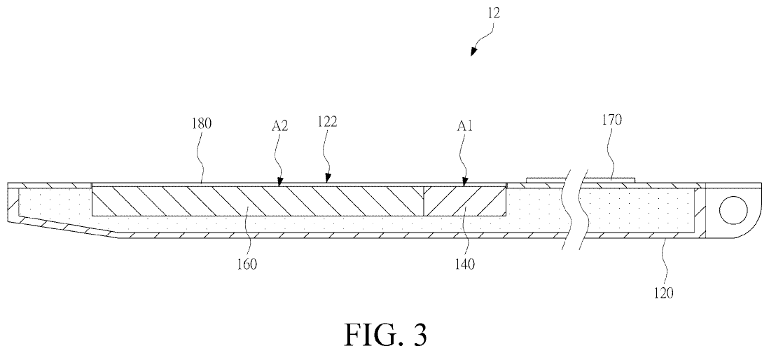

Refer to FIG. 1 to FIG. 3. FIG. 1 is a three-dimensional schematic diagram of an electronic device according to an embodiment of the disclosure. FIG. 2 is a schematic top view of a host part of the electronic device in FIG. 1. FIG. 3 is a schematic cross-sectional view corresponding to a section line A-A in FIG. 2. In an embodiment, an electronic device 10 is a notebook computer. A touch display module is used as a secondary screen. However, the disclosure is not limited thereto. In another embodiment, the electronic device 10 is also an input device.

As shown in the figure, the electronic device 10 includes a host part 12 and a screen part 14. The screen part 14 is pivotally connected to the host part 12. The host part 12 has a housing 120, a touch display module 140, a touch pad 160, and a keyboard module 170.

A side of the housing 120 facing the screen part 14 is provided with the keyboard module 170 and has an opening 122. The opening 122 is substantially rectangular. The touch display module 140 is arranged in the housing 120 and includes a touch display surface A1 exposed through the opening 122. The touch pad 160 is also arranged in the housing 120 and includes a touch surface A2 exposed through the opening 122. It is to be noted that the touch display surface A1 of the touch display module 140 is next to the touch surface A2 of the touch pad 160, which form a rectangular region as a whole. The rectangular region has a shape and a size corresponding to a shape and a size of the opening 122, and is exposed through the opening 122.

In an embodiment, the electronic device 10 further includes a surface layer 180. The surface layer 180 is located in the opening 122, and covers both the touch display surface A1 and the touch surface A2, so that the whole touch region is flat. In an embodiment, the surface layer 180 is a protective layer to prevent the touch display surface A1 and the touch surface A2 from being scratched or worn. However, the disclosure is not limited thereto.

Next, in this embodiment, an area of the touch display surface A1 is smaller than an area of the touch surface A2, and the touch display surface A1 is located on a side of the touch surface A2 facing the keyboard module 170. However, the disclosure is not limited thereto. In another embodiment, based on actual requirements, the touch display surface A1 is also arranged on a side of the touch surface A2 facing an edge of the housing 120, or is arranged on a side of the touch surface A2 facing a side edge of the housing 120.

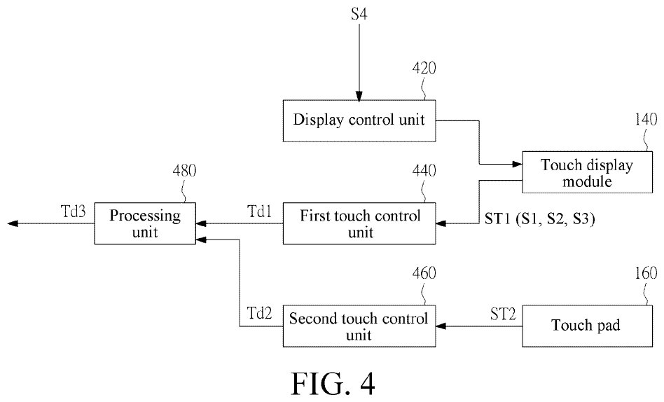

Refer to FIG. 4 additionally. FIG. 4 is a schematic block diagram of the electronic device 10 in FIG. 1.

As shown in the figure, the host part 12 of the electronic device 10 includes a display control unit 420, a first touch control unit 440, and a second touch control unit 460.

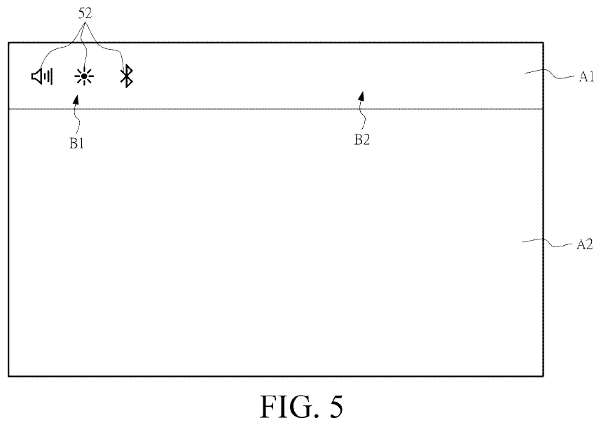

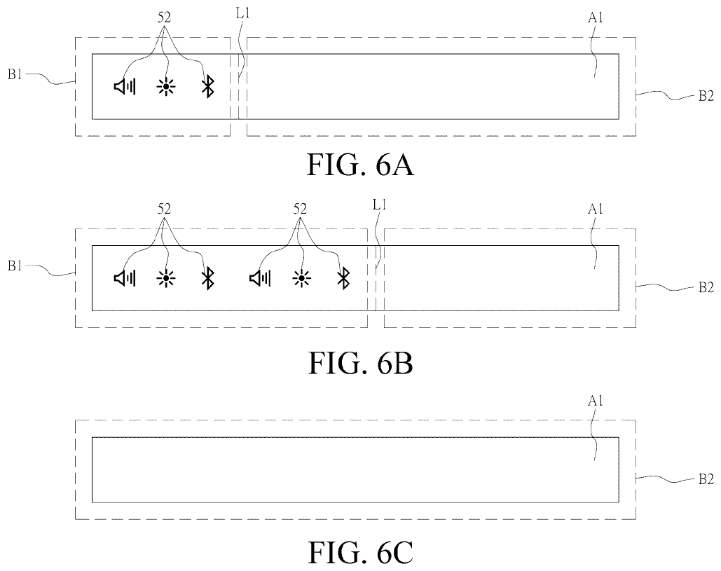

The display control unit 420 is electrically coupled to the touch display module 140, and is adapted to control a display picture of the touch display surface A1. In an embodiment, the display control unit 420 is adapted to display a first user operation interface on the touch display surface A1 in response to a first signal S1. The first user operation interface is to be described in more detail in subsequent paragraphs corresponding to FIG. 5 to FIG. 6C.

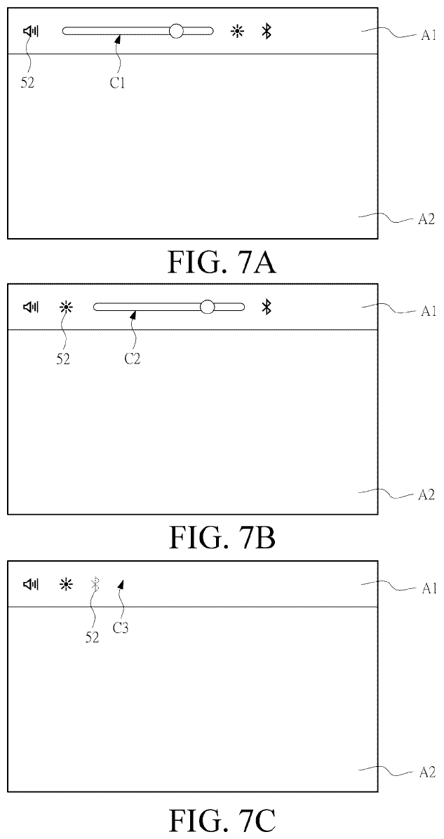

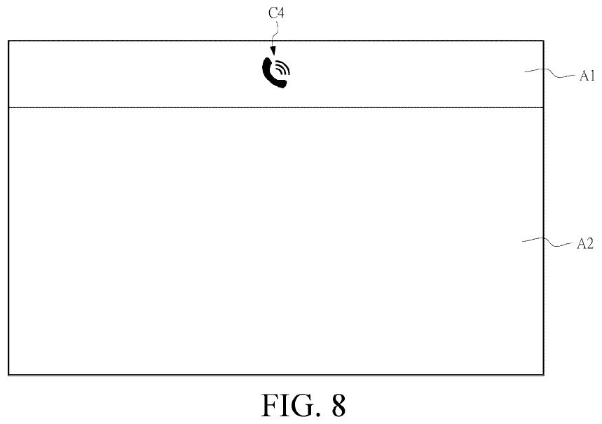

In an embodiment, the display control unit 420 is adapted to display a second user operation interface on the touch display surface A1 in response to a second signal S2 to replace the first user operation interface. The second user operation interface is to be described in more detail in subsequent paragraphs corresponding to FIG. 7A to FIG. 8.

As shown in the figure, in this embodiment, the first signal S1 and the second signal S2 are both touch signals received by the touch display module 140. However, the disclosure is not limited thereto.

The first touch control unit 440 is electrically coupled to the touch display module 140, and is adapted to receive a first touch signal ST1 from the touch display surface A1 to generate first touch data Td1. The second touch control unit 460 is electrically coupled to the touch pad 160, and is adapted to receive a second touch signal ST2 from the touch pad 160 to generate second touch data Td2.

In an embodiment, the electronic device 10 further includes a processing unit 480. The processing unit is electrically coupled to the first touch control unit 440 and the second touch control unit 460, and is adapted to receive the first touch data Td1 and the second touch data Td2 to generate output touch data Td3.

In an embodiment, the processing unit 480 selects the first touch data Td1 or the second touch data Td2 as the output touch data Td3 based on a default condition. In an embodiment, in a case that a touch function of the touch display module 140 needs to be stopped, the processing unit 480 selects the first touch data Td1 as the output touch data Td3.

In an embodiment, the processing unit 480 regards the touch display surface A1 and the touch surface A2 as a complete touch input surface, and integrates the first touch data Td1 or the second touch data Td2 to generate the output touch data Td3. In an embodiment, the processing unit 480 converts position data in the first touch data Td1 and the second touch data Td2 into position data corresponding to the complete touch input surface, so as to generate the output touch data Td3.

FIG. 5 is a schematic diagram of a first user operation interface according to an embodiment of the disclosure.

As shown in the figure, the first user operation interface includes a first region B1 and a second region B2 adjacent to each other. The first region B1 is a function key region, which displays a plurality of default function keys 52 (function keys of volume, screen brightness, and Bluetooth shown in the figure, but the disclosure is not limited thereto). The second region B2 is a self-defined display region, which is blank by default. In an embodiment, the second region B2 is used by a user as an electronic note display region. However, the disclosure is not limited thereto.

In an embodiment, the user inputs a touch signal, a key signal, or a voice control signal as a first signal S1 to trigger start of the first user operation interface. In an embodiment, the foregoing touch signal is a click signal corresponding to a specific position of a touch display surface A1 or a touch surface A2, or a specific touch trajectory. However, the disclosure is not limited thereto. In another embodiment, the first user operation interface is started by default after the electronic device 10 is turned on.

FIG. 6A to FIG. 6C are schematic diagrams of different display modes of the first user operation interface in FIG. 5.

As shown in the figure, a dividing line L1 (which is displayed by a dashed line in the figure to indicate that the dividing line L1 is a hidden line) is defined between the first region B1 and the second region B2 of the first user operation interface. The user changes a position of the dividing line L1 in the touch surface A2 based on actual requirements, so as to adjust sizes of the first region B1 and the second region B2. The dividing line L1 is a visible line or a hidden line.

In an embodiment, the user changes the position of the dividing line L1 by touching. Specifically, the first touch control unit 440 detects the touch trajectory (which is defined as a third signal S3 herein) corresponding to the position of the current dividing line L1 through the touch display module 140, and then generates touch data corresponding to the touch trajectory. The processing unit 480 generates a display control signal based on the touch data, and transmits the signal to a display control unit 420, so as to change the position of the dividing line L1.

As shown in FIG. 6B, the user increases a width of the first region B1 by dragging the position of the dividing line L1. In an embodiment, in the touch display surface A1, an upper limit of the width of the first region B1 is 50% of a width of the touch display surface A1, and the default function keys 52 are repeatedly arranged in the first region B1 based on a default arrangement order. In an embodiment, as shown in FIG. 6B, the function keys of volume, screen brightness, and Bluetooth are arranged in the first region B1. The three default function keys 52 are arranged based on an order of volume, screen brightness, and Bluetooth. In the figure, the width of the first region B1 is greater than a width required for the arrangement of the three function keys. Therefore, the three default function keys 52 are repeatedly arranged based on the order of volume, screen brightness, and Bluetooth until the first region B1 is filled. If the width of the first region B1 is less than the width required for the arrangement of the three function keys, the default function keys 52 that are not arranged are removed in sequence from right to left. However, the disclosure is not limited thereto.

Further, as shown in FIG. 6C, the user decreases the width of the first region B1 by dragging the position of the dividing line L1. In an embodiment, the user also drags the dividing line L1 to cause the first region B1 to disappear completely. In this case, the first user operation interface does not have the default function key 52, and the entire range of the touch display surface A1 is used as a custom display region.

Refer to FIG. 4, FIG. 5, and FIG. 7A to FIG. 7C together. FIG. 7A to FIG. 7C are schematic diagrams of a second user operation interface according to an embodiment of the disclosure.

When the first touch control unit 440 receives a touch signal (which is defined as a second signal S2 herein) corresponding to a specific default function key 52 of the first user operation interface, then the display control unit 420 displays a touch control region C1 on the touch display surface A1 in response to the second signal S2.

In an embodiment, as shown in FIG. 5, when the user clicks a volume function key (which is defined as a second signal S2 herein) of the first user operation interface, as shown in FIG. 7A, a volume adjustment bar (that is, the touch control region C1) then appears on a right side of the volume function key for the user to adjust a volume through the touch display surface A1 by touching, and other function keys are moved to the right. In an embodiment, the second region B2 originally located on a right side of the first region B1 disappears to accommodate the touch control region C1.

Similarly, when the user clicks a screen brightness function key (which is defined as a second signal S2 herein) of the first user operation interface, as shown in FIG. 7B, a brightness adjustment bar (that is, a touch control region C2) then appears on a right side of the screen brightness function key for the user to adjust screen brightness through the touch display surface A1 by touching, and the Bluetooth function key is moved to the right.

In addition, when the user clicks the Bluetooth function key (which is defined as a second signal S2 herein) of the first user operation interface, as shown in FIG. 7C, the Bluetooth function key then changes luminance or a color (that is, a touch control region C3) to indicate that the Bluetooth function is enabled or disabled.

Refer to FIG. 4 and FIG. 8 together. FIG. 8 is a schematic diagram of a second user operation interface according to another embodiment of the disclosure.

When the electronic device 10 enables a specific function (such as a call function), the electronic device 10 generates a trigger signal (which is defined as a fourth signal S4 herein) to the display control unit 420. The display control unit 420 then displays a prompt picture C4 on the touch display surface A1 in response to the fourth signal S4, and hides the default function key 52 originally presented on the first user operation interface.

As shown in the figure, when the electronic device 10 receives an incoming call signal (that is, the fourth signal S4), the display control unit 420 then displays a prompt picture C4 on the touch display surface A1 in response to the fourth signal S4 to prompt the user to answer the call. In this embodiment, the prompt picture C4 only displays an incoming call icon. However, the disclosure is not limited thereto. In another embodiment, the prompt picture C4 also displays information related to an incoming call, such as a telephone number and a name of a caller. Further, in an embodiment, the first touch control unit 440 stops the touch function of the touch display module 140 in response to the fourth signal S4.

When a specific function needs to be operated on a conventional notebook computer, an operation often needs to be performed through the “Fn” key on a keyboard and a corresponding function key, which causes inconvenient operation and a waste of time for a user. In the disclosure, the touch display module 140 and the touch pad 160 are arranged at the opening 122 of the housing 120 of the electronic device 10, and the touch display surface A1 of the touch display module 140 is next to the touch surface A2 of the touch pad 160, so that the user directly uses the touch display module 140 to operate (enable) the specific function. In this way, the user directly uses the touch display module 140 next to the touch pad 160 to operate (enable) the specific function without needing to switch to the keyboard, which helps shorten a movement distance of a hand of the user, enhance operation efficiency of the user, and reduce the time wasted by switching to the keyboard. In addition, the touch display module 140 further serves as an information provision channel, which is convenient for the user to grasp a current mode and state of the electronic device 10.

The foregoing descriptions are merely preferred embodiments of the disclosure, and do not impose any limitation on the disclosure. Any form of change such as an equivalent replacement or modification made by any person skilled in the art to technical means and technical content disclosed in the disclosure without departing from scope of the technical means of the disclosure is content that does not deviate from the technical means of the disclosure, and still falls within protection scope of the disclosure.

1. An electronic device, comprising:
a housing, having an opening;
a touch display module, arranged in the housing and having a touch display surface; and
a touch pad, arranged in the housing and having a touch surface, wherein
the touch display surface is next to the touch surface, and the touch display surface and the touch surface are exposed through the opening,
the touch display module and the touch pad are two independent modules, and
the touch display surface is separated from the touch surface.

2. The electronic device according to claim 1, wherein the touch display surface and the touch surface form a square region as a whole, and a size of the square region corresponds to a size of the opening.

3. The electronic device according to claim 1, further comprising a display control unit electrically coupled to the touch display module, wherein the display control unit is adapted to display a first user operation interface on the touch display surface in response to a first signal.

4. The electronic device according to claim 3, wherein the first user operation interface comprises a first region and a second region adjacent to each other, and the first region displays a plurality of default function keys.

5. The electronic device according to claim 4, wherein the display control unit is adapted to display a second user operation interface on the touch display surface in response to a second signal, to replace the first user operation interface.

6. The electronic device according to claim 5, wherein the second signal corresponds to a touch signal of one of the plurality of default function keys.

7. The electronic device according to claim 4, wherein a dividing line is defined between the first region and the second region, and the display control unit is adapted to change a position of the dividing line in response to a third signal.

8. The electronic device according to claim 5, wherein the second user operation interface comprises a touch control region.

9. The electronic device according to claim 3, wherein the display control unit is adapted to display a prompt picture on the touch display surface in response to a fourth signal.

10. The electronic device according to claim 9, further comprising a first touch control unit electrically coupled to the touch display module, wherein the first touch control unit is adapted to stop a touch function of the touch display module in response to the fourth signal.

11. The electronic device according to claim 1, further comprising a first touch control unit and a second touch control unit, wherein the first touch control unit is electrically coupled to the touch display module and is adapted to receive a first touch signal from the touch display surface to generate first touch data, and the second touch control unit is electrically coupled to the touch pad and is adapted to receive a second touch signal from the touch pad to generate second touch data.

12. The electronic device according to claim 11, further comprising a processing unit, wherein the processing unit is electrically coupled to the first touch control unit and the second touch control unit and adapted to receive the first touch data and the second touch data to generate output touch data.

13. The electronic device according to claim 1, further comprising a surface layer, wherein the surface layer covers both the touch display surface and the touch surface.

14. The electronic device according to claim 1, wherein the electronic device is a notebook computer.
